(19) United States
(12) Patent Application Publication
(10) Pub. No.: US 2003/0011180 A1
(43) Pub. Date: Jan. 16, 2003

(54) Cab shield

(76) Inventors: Jason N. Coffman, Holt, MO (US); Leland R. Carder, Rayville, MO (US)

Correspondence Address: HOVEY WILLIAMS TIMMONS & COLLINS, 2405 GRAND BLVD., SUITE 400, KANSAS CITY, MO, 64108

(21) Appl. No.: 10/193,859

(22) Filed: Jul. 12, 2002

Related U.S. Application Data
(63) Continuation-in-part of application No. 09/556,512, filed on Apr. 24, 2000.

(51) Int. Cl. B60R 21/11; B60R 21/02

(52) U.S. Cl. 280/748

(57) ABSTRACT

An improved truck cab shield (10) is provided for attachment to a pickup truck (12) in close protective relationship to the pickup's rear cab window (24). The shield (10) includes a base (18) which is secured to the bed side rails (30, 32) of the truck (12), as well as an upstanding barrier (20) supported by the base (18). In preferred forms, the barrier (18) is oriented at a non-vertical angle in close proximity to the window (24) through the height thereof. In preferred forms, the barrier (20) also includes upright, tubular elements (68, 70) allowing insertion of standards (74) which may be used to support traffic signs or the like. The barrier (20) preferably includes a peripheral frame (40) covered by wire mesh (63) and/or plexiglass panels (86).

### RELATED APPLICATIONS

This application is a continuation-in-part of application Ser. No. 09/556,512 filed on Apr. 24, 2000, the content and teachings of which are incorporated by reference herein.

### BACKGROUND OF THE INVENTION

1. Field of the Invention

The present invention is broadly concerned with improved truck cab shields designed for mounting on pickup trucks in order to prevent breakage of the rear truck cab windows in the event that a load on the truck bed shifts towards the window. More particularly, the invention pertains to such shields wherein the upright barrier thereof is oriented in a non-vertical fashion so as to closely conform with the contour of modern-day truck cabs. In addition, the barrier may support a variety of useful trucking accessories.

2. Description of the Prior Art

Owners of pickup trucks use the vehicles to transport a variety of loads having different shapes, sizes and weights. Such uses can pose a number of dangers, however. If a given load is not carefully placed on the truck bed and/or is inadequately tied down, the load may shift during travel. If the load shifts towards the cab (which may occur during sudden stops), the load can break the rear cab window or otherwise damage the truck. While this is of course to be avoided, a still greater danger is that the load may break through the rear cab window and injure the driver or passengers or be a contributing factor in accidents.

Cab shields, commonly referred to as “headache racks” have been proposed in the past to ameliorate these problems. For example, typical shields are illustrated in U.S. Pat. Nos. 4,611,824,4,564,216 and 4,692,845. Without known exception, prior cab shields have included an upright, vertically oriented shielding member which is secured by one means or another to the truck. This type of vertical shield orientation can in itself be a problem, owing to the fact that modern-day truck cabs typically have a forwardly or rearwardly inclined rear cab window frame. Thus, use of an essentially vertical shield on trucks having a forwardly inclined rear cab frame permits objects to accidentally fall between the shield and the cab window. Such objects can thereby become lodged between the truck cab and the shield and this problem is worsened by relative movement between the cab and the shield which tends to further lodge or damage the object or cab. Moreover, in the case of essentially vertical shields on trucks having a rearwardly inclined rear cab frame, the usable area of the truck bed may be reduced in order to provide clearance for the cab.

Prior cab shields are also deficient in that they have not been equipped with useful accessories. For example, individuals involved in road construction or similar tasks may wish to erect traffic signs such as directional arrows on their trucks. In the past, the cab shields have not made any provision for such uses.

There is accordingly a need in the art for improved truck cab shields which include an upright barrier oriented in a forwardly or rearwardly directed, non-vertical fashion to conform with modern truck cab contours, while also being equipped with a number of desirable accessories.

### SUMMARY OF THE INVENTION

The present invention overcomes the problems outlined above and provides a truck cab shield (headache rack) operable to prevent breakage of the truck cab rear window in the event that a load on the truck bed shifts toward the window. The cab shield broadly includes a connection base designed for attachment to the truck and preferably the bed side rails thereof, together with a barrier supported by the base. The barrier is oriented at a non-vertical angle and is in close proximity to the cab window throughout the height thereof.

In preferred forms, the barrier is in the form of a tubular metallic frame with heavy gauge wire mesh and/or plexiglass covering the frame. The frame is welded to a pair of laterally spaced apart, apertured connection legs configured to overlie and be attached to the truck side rails. Preferably, the connection legs are at least 12 inches in length and still more preferably, at least 18 inches in length.

The invention also provides a number of optional accessories mounted on the cab shield, including upright tubular elements, tie down clips, supplemental brake/tail lights, ladder retainers, winches, aerial mounting tabs, and apertured tabs for supporting lights and antennas.

It is understood that the terms “cab shield” and “headache rack” are interchangeable terms which refer to a specialized apparatus intended for use on a vehicle which has a bed for the storage and transportation of items such as a pickup truck or the like. The cab shield or headache rack generally includes a connection base which is adapted to be secured to the truck's bed or siderails and an upstanding barrier or shield connected to the base. This shield or barrier portion of the headache rack preferably covers substantially all the rear window of a truck and prevents all or part of a load carried in the bed of a truck from shifting forward toward the cab's rear window and breaking the rear window thereof.

### BRIEF DESCRIPTION OF THE DRAWINGS

FIG. 1 is a rear view of a pickup truck illustrating the truck cab, rear cab window, and truck bed, with the cab shield of the invention mounted on the truck in protecting relationship to the cab window;

FIG. 2 is a fragmentary side view of the truck with the cab shield mounted thereon;

FIG. 3 is a fragmentary perspective view with parts broken away of a cab shield in accordance with the invention;

FIG. 4 is a side elevational view of a cab shield pursuant to the invention, with accessories mounted on the shield;

FIG. 5 is a plan view of the shield depicted in FIG. 4;

FIG. 6 is a rear view of a cab shield similar to that shown in FIG. 1, but having a plexiglass insert as well as a plurality of top-mounted lights;

FIG. 7 is a rear view of another embodiment of the invention having a different plexiglass insert and front-facing lights;

FIG. 8 is a side view of an embodiment for trucks having a rearwardly inclined cab;

FIG. 9 is a rear view of a cab shield used in conjunction with a conventional ladder rack; and,

FIG. 10 is a side view of a cab shield in accordance with the present invention having tubular elements and winches and used in conjunction with a ladder rack.

### DETAILED DESCRIPTION OF THE PREFERRED EMBODIMENT

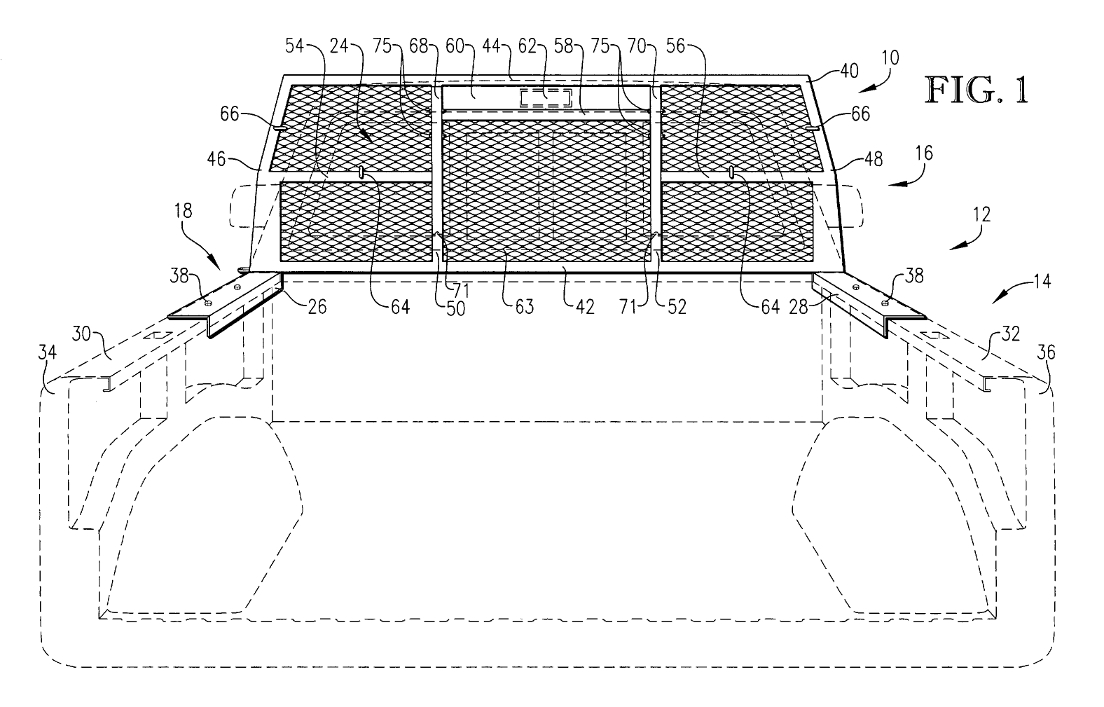

Turning now to the drawings, FIG. 1 illustrates a truck cab shield 10 mounted on a conventional pickup truck 12. The truck 12 includes a rear load bed 14 as well as a forward cab 16. The shield 10 broadly includes a connection base 18 as well as an upstanding barrier 20. As shown, the shield 10 is mounted on the truck 12 in protecting relationship to the rear face of cab 16, the latter including a frame 22 and window 24.

In more detail, the base 18 preferably in the form of a pair of laterally spaced apart, apertured metallic legs 26, 28 each of generally L-shaped cross-section. The legs 26, 28 are configured to overlie the topmost panels 30, 32 forming a part of the bed side rails 34, 36. As illustrated, bolts 38 passing through the upper webs of the legs 26, 28 and the panels 30, 32 secure the base 18 to truck 10.

The barrier 20 includes a peripheral frame 40 made up of integrally attached, preferably welded tubular frame members; this frame 40 is in turn secured, preferably by welding, to the base legs 26, 28. In particular, the frame 40 includes a bottom rail 42, top rail 44, endmost side rails 46, 48, intermediate upright rails 50, 52 and lateral intermediate rails 54, 56. Finally, transverse intermediate rail 58 extends between the upright rails 50, 52 below top rail 44 so as to define an open region 60. The brake light 62 of the truck is located adjacent the region 60 so that the brake light is not blocked or its illumination diminished. The frame rails 42-58 are each hollow tubular members as illustrated in FIG. 3, and are preferably welded together in the orientation shown. In the FIG. 1 embodiment, a continuous sheet of heavy gauge wire mesh 63 is welded to the front face of the frame 40, in covering relationship to all of the open regions defined by the frame, save for the region 60.

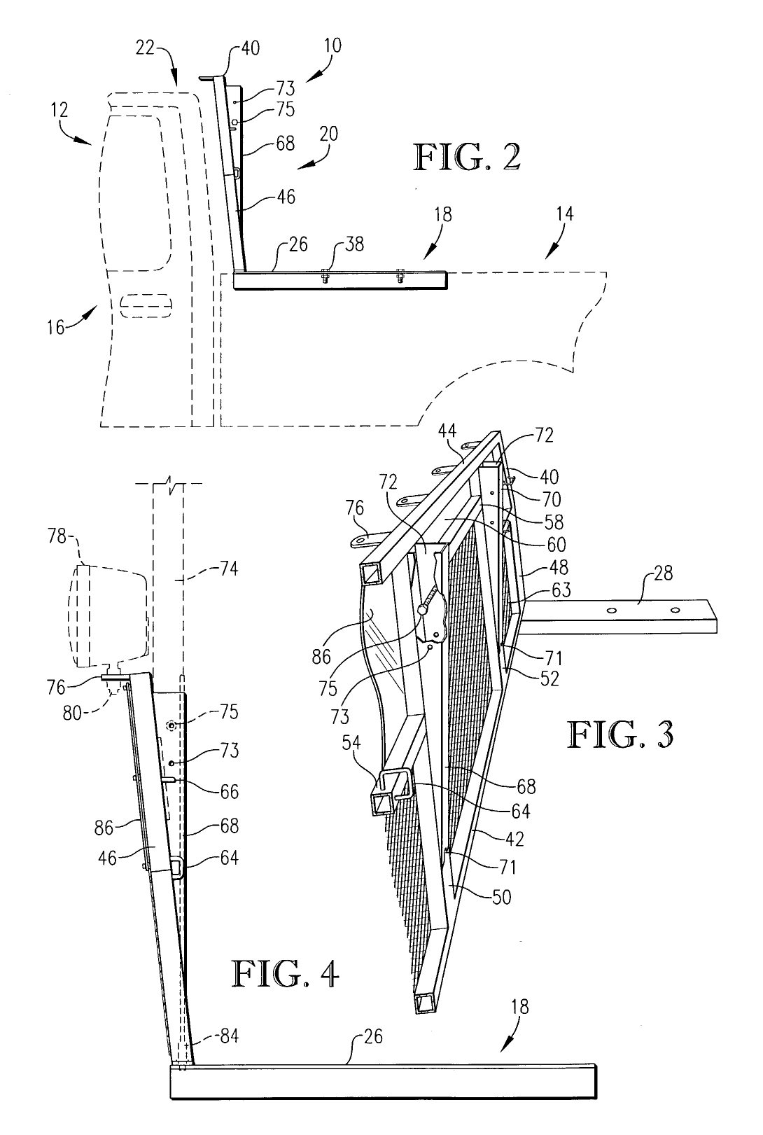

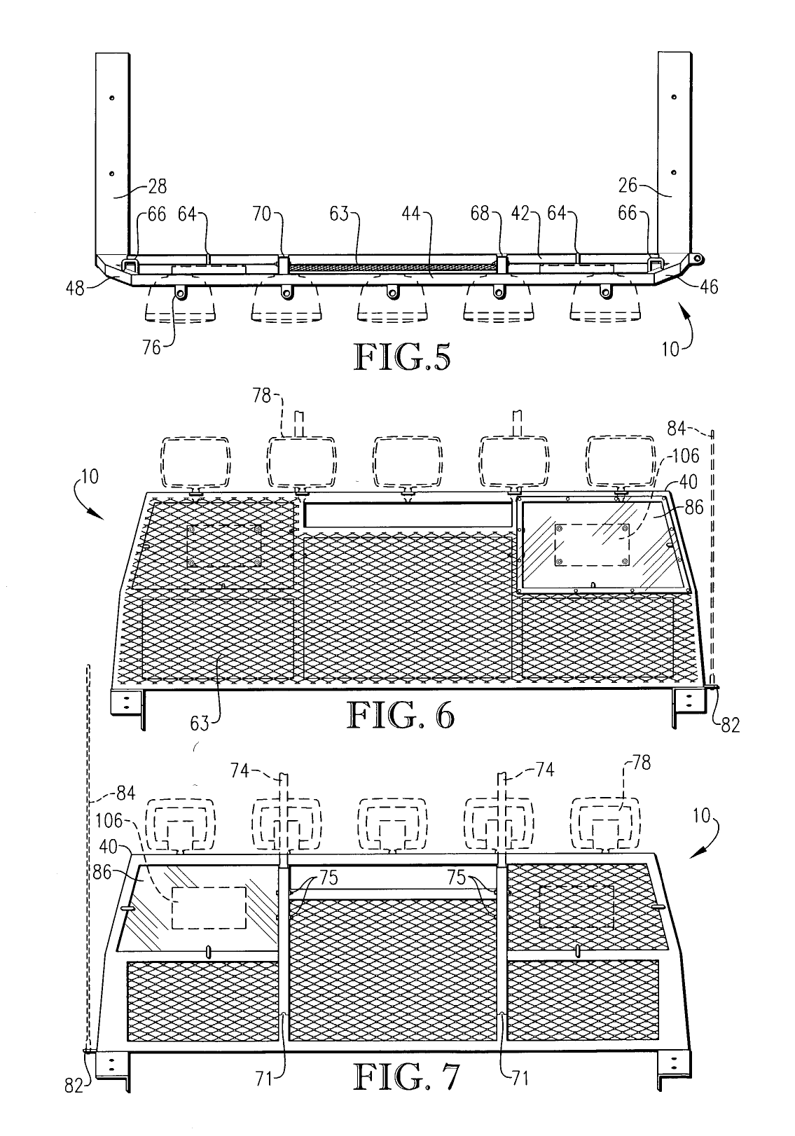

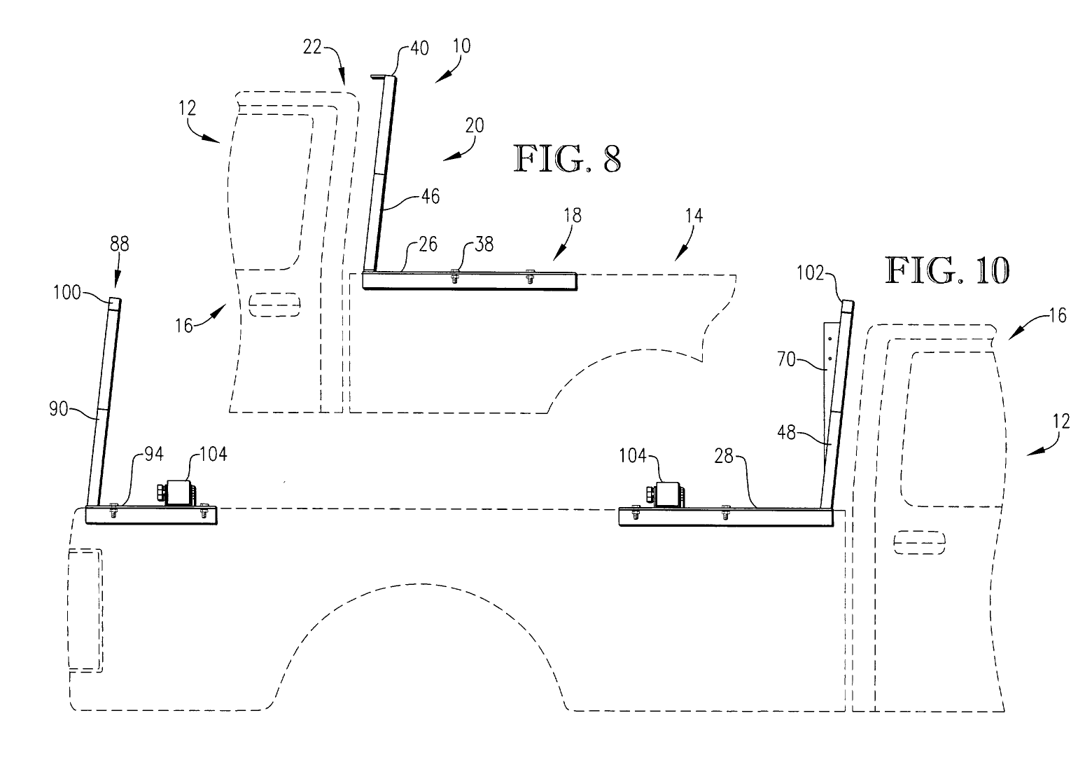

An important feature of the invention is the orientation of the barrier 20. Instead of the essentially vertical orientation in prior art shields, barrier 20 is oriented in a non-vertical angle so as to closely follow the contour of cab window frame 22. This is best illustrated in FIG. 2 where it will be observed that the barrier 20 is located so that the included angle between the barrier 20 and the base 18 is greater than 90°. Also, by virtue of this orientation, the barrier 20 is in close proximity to cab window 24 throughout the height thereof. In the case of a cab 16 having a rearwardly inclined rear window, barrier 20 is oriented such that the included angle between the barrier 20 and the base 18 is less than 90°, thereby keeping the barrier 20 in close proximity to cab window 24 throughout the height thereof (see FIG. 8).

The shield of the invention may be equipped with a number of accessory mounts in order to enhance the utility thereof. For example, as shown in FIG. 1, vertical and horizontal tie down clips 64, 66 may be attached to the rails 54, 56 and 46, 48 as shown. This allows attachment of tie down ropes or bungee cords to secure loads carried in the bed of the truck. Clips 64, 66 may be of any shape or orientation provided that they include an area to which tie down ropes, bungee cords, or the like can be secured. Another useful accessory for the shield 10 comprises a pair of laterally spaced apart hollow tubular elements 68, 70 secured to the rear faces of the frame rails 50, 52. As best seen in FIG. 3, each of the elements 68, 70 is hollow throughout its length and presents an uppermost open end 72. The elements 68, 70 allow insertion of an elongated standard 74 (see FIG. 4) which may support traffic signs, flagpoles, or the like. Although elements 68, 70 are depicted as being of diminishing cross-sectional area, it is understood that any shape or size is possible provided that elements 68, 70 permit the insertion of an elongated or oversized standard therein. One such example of this permitted variation is the length difference in elements 68, 70 which is noted between the embodiments of FIG. 3 and the embodiment of FIG. 7

In order to prevent water from accumulating in elements 68, 70, it is useful to provide a drain hole 71 near the lower end of each element 68, 70 (see FIGS. 3 and 8 for drain hole placement). These drain holes 71 allow water and air to pass through elements 68, 70, thereby reducing the likelihood of corrosion. At least one pin hole 73 is preferably provided through the sides of elements 68, 70. This pin hole 73 is adapted to receive a cotter pin or bolt 75 or the like therethrough such that the height of the elongated standard 74 can be varied. Of course, an infinite number of pin holes 73, can be placed through elements 68, 70 and the elongated standard 74 may also present corresponding pinholes such that cotter pins 75 would extend through elements 68, 70 and through a standard 74 inserted therein. This type of configuration is illustrated in FIG. 8 and would serve to further secure standard 74 in elements 68, 70.

If desired, the top rail 44 may be equipped with a plurality of projecting apertured tabs 76 which are designed to project either rearwardly (FIG. 6) or forwardly from top rail 44 and support lights 78. For this purpose, conventional threaded fasteners 80 are used to secure the lights 78 to each individual tab 76. Such lights 78 can then be positioned to illuminate in any desired direction.

Lateral tab 82 may be secured to the frame 40 in order to support a CB antenna 84. The tab 82 is similar to the tabs 78, and is preferably mounted adjacent the bottom of the frame 40 as best seen in FIGS. 6 and 7.

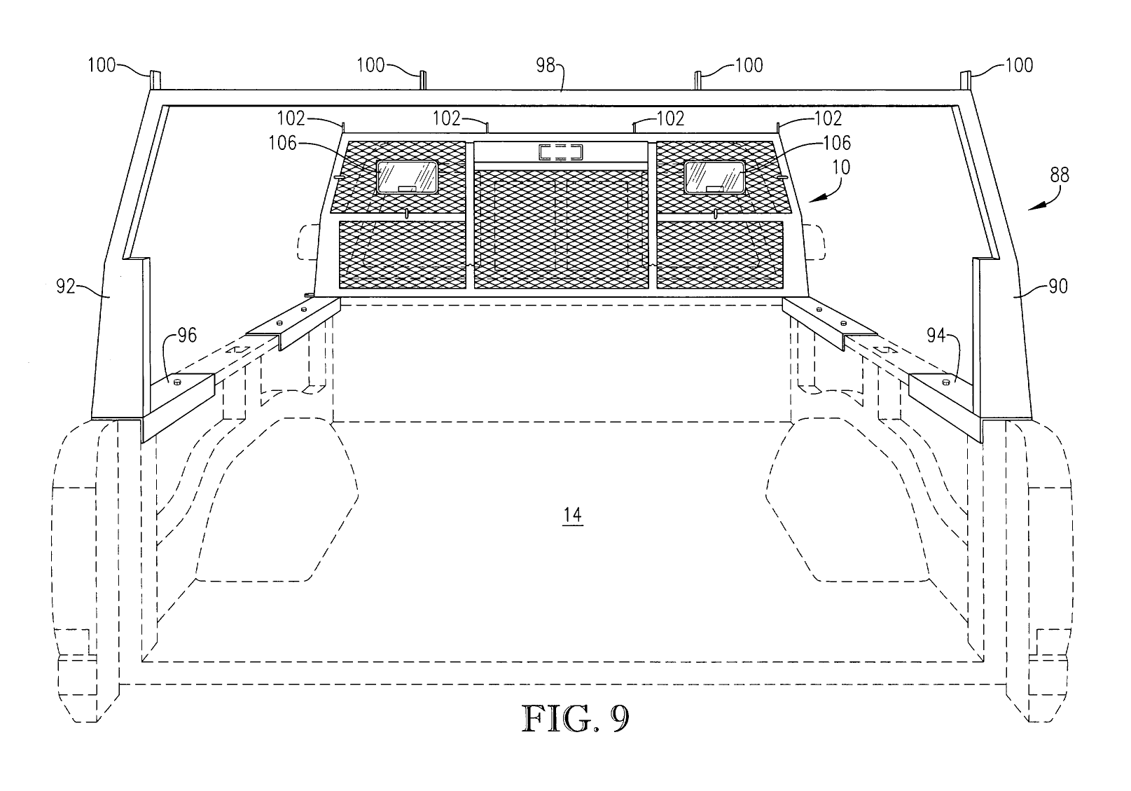

FIG. 9 illustrates that shield 10 may be secured to or used in conjunction with a ladder rack 88. Along these lines, the rack 88 presents tubular side members 90, 92 having legs 94, 96 secured to the bed side rails 34, 36 and a tubular crossbar 98 in a spanning relationship therebetween. Crossbar 98 includes at least one and preferably a plurality of upwardly projecting thumbs 100 which are operable for retaining ladders on rack 88. Similarly, thumbs 102 are also provided on top rail 44 of shield 10. In this manner, ladders can extend between and be supported on the shield 10 and rack 88. One alternative embodiment of a combination ladder rack 88 and shield 10 would present legs 26, 28 in an integral relationship with legs 94, 96 such that the legs 26, 28, 94, 96 are of unitary construction.

FIG. 10 illustrates yet another useful accessory, a winch 104 secured to any of the legs 26, 28, 94, 96. Winch 104 can be any type of conventional winch useful for securing, towing and pulling items. Preferably, winch 104 is a ratchet-type winch which is easily mounted to legs 26, 28, 94, 96.

Finally, although the FIG. 1 embodiment illustrates the use of a sheet of mesh 63 covering all of the frame openings (save for that of region 60), the invention is not so limited. Thus, one or more plexiglass panels 86 may be attached to the frame 40 as desired. For example, if a given truck is equipped with a supplemental set of brake/tail lights 106, the user may elect to employ a panel 86 at that location. Of course, the plexiglass could also be used throughout the barrier 20 if desired. Additionally, it is contemplated that the sheet of mesh 63, panels 86, elements 68, 70, projecting tabs 76, lateral tab 82, and clips 64, 66 may all be located on either side of the frame 40.

We claim:

1. In a headache rack adapted for connection to a truck having a cab, a rear cab window, and a bed behind the rear cab window, said rack operable to prevent breakage of the cab window in the event that the load on the bed shifts towards the window, said rack including a connection base and an upstanding barrier supported by the base, the improvement which comprises the barrier oriented at a non-vertical angle such that said rack is in close proximity to the rear window of the truck throughout the height thereof.

2. The headache rack of claim 1, said barrier comprising wire mesh.

3. The headache rack of claim 1, said barrier comprising plexiglass.

4. The headache rack of claim 1, said connection base including a pair of rearwardly extending legs for connection with the side rails of the truck on opposite sides of said bed.

5. The headache rack of claim 4, said legs having a length of at least about 18 inches.

6. The headache rack of claim 4, the angle between said barrier and said legs being greater than 90°.

7. The headache rack of claim 4, the angle between said barrier and said legs being less than 90°.

8. The headache rack of claim 1, said barrier including at least one upstanding, hollow mounting tube, said tube presenting an uppermost open end for receipt of a standard or the like within the tube.

9. The headache rack of claim 8, said barrier including a pair of laterally spaced apart mounting tubes.

10. The headache rack of claim 1, said barrier presenting a peripheral frame secured to said base.

11. The headache rack of claim 10, said peripheral frame including a bottom rail, a top rail and end rails interconnecting said top and bottom rails.

12. The headache rack of claim 1, including at least one apertured mounting tab secured to the top of said barrier for permitting attachment of a light to the barrier.

13. The headache rack of claim 1, including an apertured aerial-mounting tab extending laterally from a side margin of said barrier.

14. The headache rack of claim 1, including at least one cargo tie down clip secured to said barrier.

15. The headache rack of claim 1, including a ladder rack secured to the bed of the truck.

16. The headache rack of claim 15, said ladder rack including two upright members and a crossbar in a spanning relationship therebetween.

17. The headache rack of claim 16, said crossbar including at least one upwardly projecting thumb.

18. The headache rack of claim 11, said top rail including at least one upwardly projecting thumb.

19. The headache rack of claim 1, further comprising a winch mounted to said shield.

20. In a truck cab shield adapted for connection to a truck having a cab, a rear cab window, and a bed behind the cab window, said shield operable to prevent breakage of the cab window in the event that the load on the bed shifts towards the window, said shield including a connection base and an upstanding barrier supported by the base, the improvement which comprises at least one upstanding, hollow mounting tube attached to said shield and further comprising said barrier oriented at a non-vertical angle and in close proximity to the window throughout the height thereof.
